(19) United States
(12) Patent Application Publication
(10) Pub. No.: US 2014/0093182 A1
(43) Pub. Date: Apr. 3, 2014

(54) IMAGE PICKUP APPARATUS AND IMAGE PICKUP CONTROL APPARATUS

(71) Applicant: Sony Corporation, Tokyo (JP)

(72) Inventor: Hiroshi Arai, Kanagawa (JP)

(73) Assignee: Sony Corporation, Tokyo (JP)

(21) Appl. No.: 14/037,910

(22) Filed: Sep. 26, 2013

(30) Foreign Application Priority Data
Oct. 1, 2012 (JP) 2012-219536

(51) Int. Cl. H04N 7/30

(52) U.S. Cl. CPC H04N 19/00824
USPC 382/235

(57) ABSTRACT

Provided is an image pickup apparatus including: an image pickup unit configured to pick up an image; a frequency decomposition unit configured to frequency-decompose the picked-up image into one or more high-frequency images of high frequency components and a low-frequency image of a low frequency component; a first encoding unit configured to encode the high-frequency images to generate encoded high-frequency images; an image processing unit configured to subject the low-frequency image to image processing to generate an adjusted low-frequency image; a difference generation unit configured to generate difference information for the adjusted low-frequency image and the low-frequency image; a second encoding unit configured to encode the difference information to generate encoded difference information; and a transmission unit configured to transmit the encoded high-frequency images, the encoded difference information, and the adjusted low-frequency image.

### CROSS REFERENCE TO RELATED APPLICATIONS

The present disclosure contains subject matter related to that disclosed in Japanese Priority Patent Application JP 2012-219536 filed in the Japan Patent Office on Oct. 1, 2012, the entire content of which is hereby incorporated by reference.

### BACKGROUND

The present disclosure relates to an image pickup apparatus and an image pickup control apparatus with which image processing can be optimized in a simultaneous operation of a 4K Hi-Vision image and an HD image.

In recent years, along with progresses in high-resolution television broadcasts, high-resolution images of 4K Hi-Vision, 8K Super Hi-Vision, and the like are starting to be used. Up to now, in broadcast stations and the like, a simultaneous operation of an HD (High Definition) image and an SD (Standard Definition) image has been carried out. In the HD/SD simultaneous operation, an operation for HD has been the main operation in general, and even when detail processing is carried out on the HD image on an earlier-stage camera side, if the HD image is down-converted to an SD image on a later-stage CCU (Camera Control Unit) side, an effect of the HD detail processing at the earlier stage is weakened. In addition, since there is no feeling of strangeness even when SD detail processing is additionally performed on the down-converted image, the HD image subjected to the detail processing and the SD image obtained by down-converting the processed HD image have both been used.

It should be noted that a detail refers to an outline signal and is also referred to as sharpness. The detail signal is an edge signal imparted to a part with a luminance difference. In the detail processing, an image quality is adjusted by adjusting a detail signal intensity and an outline width. The detail is an aliasing created in a camera, and with a large detail width, a texture is apt to be lost when the image is displayed on a large screen or up-converted.

Moreover, there is outline emphasis processing as a technique similar to the detail processing, and there is also a technique that prevents an effect of the outline emphasis processing from weakening along with an image contraction.

For example, in a picture data formation method used in a hierarchical picture file disclosed in Japanese Patent Application Laid-open No. Hei 7-212751, by combining a simple low-pass filter and an outline emphasis filter, picture data having a favorable picture quality can be hierarchically encoded with a small number of operations. Since the outline emphasis processing is carried out hierarchically in the hierarchical picture file structure, picture data having an improved picture quality is less apt to lose its sharpness by other processing. In this technique, processing of performing an outline emphasis on each of a plurality of resolution hierarchies and encoding and storing a difference between adjacent resolutions is carried out.

### SUMMARY

As described above, in the HD/SD simultaneous operation, an HD image subjected to the detail processing has been mainly used, and even when down-converted to an SD image, an effect of HD detail processing has been small.

However, in a 4K Hi-Vision/HD simultaneous operation that is expected to be used increasingly from now on, an HD image subjected to detail processing is expected to be used mainly, and when such an image is up-converted to a 4K Hi-Vision image, an effect of the HD detail processing is emphasized too much to result in an unnatural image, which is problematic.

In view of the circumstances as described above, there is a need for an image pickup apparatus and an image pickup control apparatus with which image processing can be optimized in a simultaneous operation of a 4K Hi-Vision image and an HD image.

(1) According to an embodiment of the present disclosure, there is provided an image pickup apparatus including: an image pickup unit configured to pick up an image; a frequency decomposition unit configured to frequency-decompose the picked-up image into one or more high-frequency images of high frequency components and a low-frequency image of a low frequency component; a first encoding unit configured to encode the high-frequency images to generate encoded high-frequency images; an image processing unit configured to subject the low-frequency image to image processing to generate an adjusted low-frequency image; a difference generation unit configured to generate difference information for the adjusted low-frequency image and the low-frequency image; a second encoding unit configured to encode the difference information to generate encoded difference information; and a transmission unit configured to transmit the encoded high-frequency images, the encoded difference information, and the adjusted low-frequency image.

In this embodiment, the difference information with respect to the low-frequency image from before the image processing is transmitted together with the low-frequency image subjected to the image processing. Therefore, in the image pickup apparatus, the low-frequency image from the image processing can be restored based on the difference information. As a result, also when up-converting the low-frequency image in the image pickup control apparatus, an appropriate up-conversion can be performed without being affected by the image processing carried out on the low-frequency image in the image pickup apparatus. Using the 4K Hi-Vision image and the HD image as targets to be used in the embodiment of the present disclosure, the image processing can be optimized in the simultaneous operation of the 4K Hi-Vision image and the HD image.

(2) In the image pickup apparatus, the image processing unit may carry out, as the image processing, at least detail processing for emphasizing an outline.

In this embodiment, the detail processing is one of the image processing as a target. Since the detail processing is processing for emphasizing a high-frequency component in an image, when the image is up-converted, the processed high-frequency-component portion is emphasized too much. Therefore, by applying the embodiment of the present disclosure, the detail processing can be optimized.

(3) In the image pickup apparatus, the frequency decomposition unit may carry out the frequency decomposition by a wavelet conversion.

In this embodiment, since the frequency decomposition is carried out by the wavelet conversion, when a 4K Hi-Vision image is input, for example, one HD-size low-frequency image and three HD-size high-frequency images are generated. Consequently, handling of the images after that can be simplified.

(4) The image pickup apparatus may further include an output unit configured to output the generated adjusted low-frequency image.

In this embodiment, the adjusted low-frequency image, that is, an HD image having an adjusted image quality when a 4K Hi-Vision camera is used, for example, is output from the output unit. Therefore, even with a 4K Hi-Vision camera, an operation using an HD image is possible.

(5) According to an embodiment of the present disclosure, there is provided an image pickup control apparatus including: an input unit configured to input encoded high-frequency images, encoded difference information, and an adjusted low-frequency image transmitted from an image pickup apparatus including an image pickup unit that picks up an image, a frequency decomposition unit that frequency-decomposes the picked-up image into one or more high-frequency images of high frequency components and a low-frequency image of a low frequency component, a first encoding unit that encodes the high-frequency images to generate the encoded high-frequency images, an image processing unit that subjects the low-frequency image to image processing to generate the adjusted low-frequency image, a difference generation unit that generates difference information for the adjusted low-frequency image and the low-frequency image, a second encoding unit that encodes the difference information to generate the encoded difference information, and a transmission unit that transmits the encoded high-frequency images, the encoded difference information, and the adjusted low-frequency image; a first reverse encoding unit configured to reverse-encode the encoded high-frequency images to restore them to the high-frequency images; a second reverse encoding unit configured to reverse-encode the encoded difference information to restore it to the difference information; a restoration unit configured to restore the low-frequency image from before the image processing based on the restored difference information and the adjusted low-frequency image; and a frequency reverse decomposition unit configured to subject the restored high-frequency images and the restored low-frequency image to a frequency reverse decomposition to restore and output the image.

In this embodiment, the difference information with respect to the low-frequency image from before the image processing is transmitted from the image pickup apparatus together with the low-frequency image subjected to the image processing in the image pickup apparatus. Therefore, in the image pickup control apparatus, the low-frequency image from before the image processing can be restored based on the difference information. As a result, also when up-converting the low-frequency image in the image pickup control apparatus, an up-conversion can be appropriately carried out without being affected by the image processing that has been carried out on the low-frequency image in the image pickup apparatus. Using the 4K Hi-Vision image and the HD image as targets to be used in the embodiment of the present disclosure, the image processing can be optimized in the simultaneous operation of the 4K Hi-Vision image and the HD image.

(6) In the image pickup control apparatus, the frequency reverse decomposition unit may carry out the frequency reverse decomposition by a wavelet reverse conversion.

In this embodiment, since the frequency reverse decomposition is carried out by the wavelet reverse conversion, when an HD image is input, for example, the image can be up-converted to a 4K Hi-Vision-size image

(7) The image pickup control apparatus may further include an output unit configured to output the input adjusted low-frequency image.

In this embodiment, the adjusted low-frequency image, that is, an HD image having an adjusted image quality when a CCU used in combination with a 4K Hi-Vision camera is used, for example, is output from the output unit. Therefore, the simultaneous operation of the 4K Hi-Vision image and the HD image can be performed.

As described above, according to the embodiments of the present disclosure, the image processing can be optimized in the simultaneous operation of the 4K Hi-Vision image and the HD image.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a general outline of a 4K/HD simultaneous operation system;

FIG. 2 is a block diagram showing a structure of a 4K Hi-Vision camera used in an embodiment of the present disclosure; and

FIG. 3 is a block diagram showing a structure of a CCU used in the embodiment of the present disclosure.

### DETAILED DESCRIPTION OF EMBODIMENTS

Hereinafter, an embodiment of the present disclosure will be described with reference to the drawings.

### First Embodiment

(Preconditions of Present Disclosure)

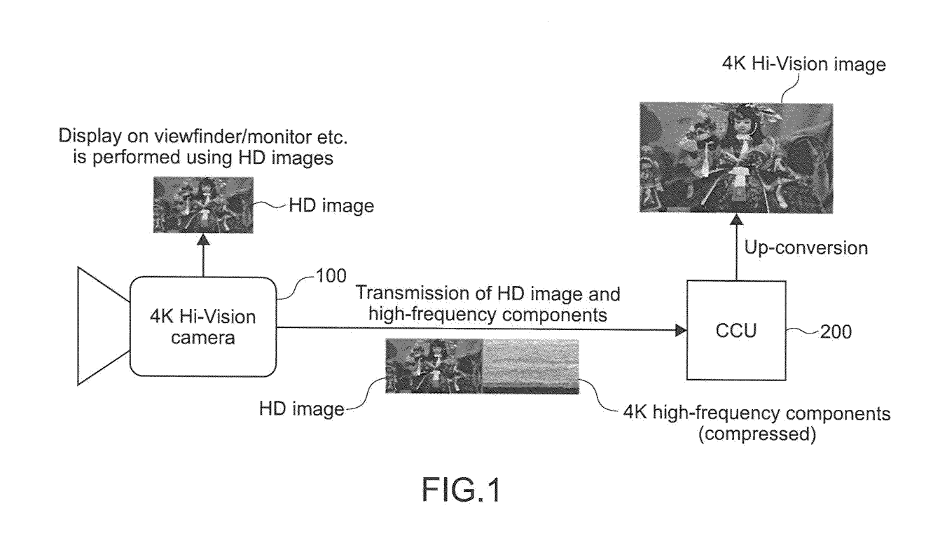

The present disclosure is constituted of a camera that photographs a 4K Hi-Vision image and a CCU and presupposes a system in which a simultaneous operation of a 4K Hi-Vision image and an HD image is carried out. FIG. 1 is a diagram showing a general outline of a 4K/HD simultaneous operation system. In this system, a 4K Hi-Vision camera 100 and a CCU 200 are connected by a 3G-SDI cable as shown in the figure.

In the 4K Hi-Vision camera 100, a photographed 4K image is frequency-decomposed by a wavelet conversion, for example. In the wavelet conversion, an image is separated into one low-frequency-component image and three high-frequency-component images. The low-frequency image becomes an HD-size image and is operated as a main image in the system. The three high-frequency-component images are used in up-converting the HD image in the CCU 200 and restoring the 4K Hi-Vision image.

In the CCU 200, an operation is made using the HD image transmitted from the 4K Hi-Vision camera 100, and by performing a wavelet reverse conversion from the HD image (low-frequency component) and the three high-frequency-component images as necessary, the original 4K Hi-Vision image is restored and used.

(Problem of Detail Processing in Simultaneous Operation)

In the HD/SD simultaneous operation, an operation for HD is the main operation in general as described above, and even when detail processing is carried out on an HD image on an earlier-stage camera side, if the HD image is down-converted to an SD image on a later-stage CCU side, an effect of the HD detail processing at the earlier stage is weakened. In addition, since there is no feeling of strangeness even when SD detail processing is additionally performed on the down-converted image, the HD image subjected to the detail processing and the SD image obtained by down-converting the processed HD image have both been used.

In contrast, in the 4K/HD simultaneous operation, from the fact that an infrastructure that uses an HD image is already completed and from restrictions on a viewfinder size, it is expected that an operation will still be made mainly using an HD image in the future. In this regard, as described in the preconditions above, when the detail processing is carried out on the HD image on the earlier-stage camera side and the HD image subjected to the detail processing is up-converted to a 4K image on the later-stage CCU side, an effect of the HD detail processing at the earlier stage appears fairly strongly to thus cause a technical problem.

The reason why the effect of the detail processing appears fairly strongly when the image subjected to the detail processing is up-converted is because the high-frequency component is emphasized excessively.

Specifically, in the 4K/HD simultaneous operation system that mainly performs an operation of an HD image, it can be understood that it is difficult to apply processing that uses an algorithm for adjusting a high-frequency component to an HD image that has not yet been up-converted. The processing that uses the algorithm for adjusting a high-frequency component is, for example, processing such as the detail processing and an aberration correction.

(Review of Countermeasure on Detail Processing Problem)

Next, a countermeasure for the detail processing problem will be discussed.

As a simple countermeasure, also transmitting an HD image that has not been subjected to the detail processing from the camera to the CCU in addition to the HD image subjected to the detail processing can be considered. However, transmitting two HD images results in a redundant design, and thus a wasteful transmission band is caused.

Further, performing the detail processing individually on the HD images when outputting the HD images from the camera or CCU to an HD monitor can be considered. With this method, however, in addition to the camera and the CCU, the detail processing also needs to be carried out individually in later-stage apparatuses, which is inefficient. Furthermore, since the detail processing is performed individually, there is a possibility that a trouble in which the detail processing set by a VE (Video Engineer) is not carried out may occur.

In this regard, in the present disclosure, generating difference information for restoring a high-frequency component in the HD image adjusted by the detail processing and restoring the HD image from before the detail processing on the camera side and transmitting the difference information to the CCU together with the HD image subjected to the detail processing is considered. The difference information is difference information for the HD image from before the detail processing and the HD image subjected to the detail processing.

In generating a 4K Hi-Vision image by an up-conversion on the CCU side that has received the difference information, a low-frequency-component image, that is, an HD image is restored to the state from before the detail processing from the state after the detail processing using the difference information. In other words, processing such as de-gamma processing for restoring a state to its original state from before gamma processing is carried out, for example.

Since the high-frequency component of the HD image used in the up-conversion is restored to the state from before the detail processing by the difference information, even when the up-conversion processing is carried out, the high-frequency component can be prevented from being emphasized excessively. Therefore, the detail processing for a 4K Hi-Vision image can be carried out appropriately also with respect to the restored 4K Hi-Vision image.

(Structure of 4K Hi-Vision Camera 100)

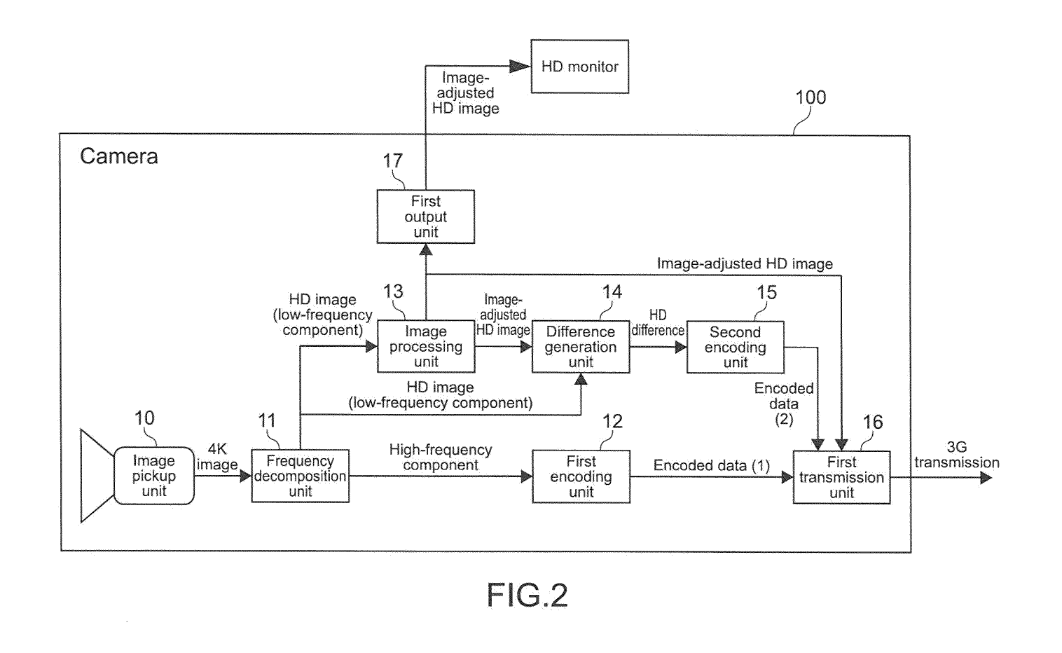

Next, a structure of the 4K Hi-Vision camera 100 used in the present disclosure will be described. FIG. 2 is a block diagram showing the structure of the 4K Hi-Vision camera used in an embodiment of the present disclosure.

The 4K Hi-Vision camera 100 (image pickup apparatus) includes an image pickup unit 10, a frequency decomposition unit 11, a first encoding unit 12, an image processing unit 13, a difference generation unit 14, a second encoding unit 15, a first transmission unit 16, and a first output unit 17.

The image pickup unit 10 picks up a 4K Hi-Vision image and supplies the picked-up image to the frequency decomposition unit 11.

The frequency decomposition unit 11 carries out frequency decomposition processing on the image supplied from the image pickup unit 10. As the frequency decomposition processing, a wavelet conversion is carried out, for example. When the wavelet conversion is carried out on the 4K Hi-Vision image, one HD-size low-frequency-component image (low-frequency image) and three HD-size high-frequency-component images (high-frequency images) are generated. The frequency decomposition unit 11 supplies the high-frequency-component images to the first encoding unit 12 and supplies the low-frequency-component image to the image processing unit 13 for image processing and also to the difference generation unit 14 for generating difference information.

The first encoding unit 12 compresses data by performing encoding such as Huffman coding and scramble superimposition encoding with respect to the high-frequency-component images supplied from the frequency decomposition unit 11. The first encoding unit 12 supplies the encoded high-frequency-component images (encoded high-frequency images) to the first transmission unit 16 for transmission to the CCU 200. It should be noted that the first encoding unit 12 may carry out processing for putting together a plurality of high-frequency-component images in encoding the high-frequency components.

The image processing unit 13 carries out image processing including the detail processing on the low-frequency-component image supplied from the frequency decomposition unit 11. The image processing unit 13 supplies the low-frequency-component image subjected to the image processing (adjusted low-frequency image) to the difference generation unit 14 for generating difference information, the first output unit 17 for a monitor output, and the first transmission unit 16 for transmission to the CCU 200.

The first output unit 17 outputs, as an HD image, the low-frequency-component image that has been supplied from the image processing unit 13 and subjected to the image processing to an external apparatus such as a monitor.

The difference generation unit 14 compares the low-frequency-component image that has been supplied from the image processing unit 13 and subjected to the image processing with the low-frequency-component image from before the image processing, that has been supplied from the frequency decomposition unit 11, and generates a difference between the images as difference information. The difference generation unit 14 supplies the generated difference information to the second encoding unit 15.

The second encoding unit 15 encodes the difference information supplied from the difference generation unit 14. The same encoding method as that used in the first encoding unit 12 may be used, or an encoding method corresponding to the difference information may be used. The second encoding unit 15 supplies the encoded difference information (encoded difference information) to the first transmission unit 16 for transmission to the CCU 200.

The first transmission unit 16 transmits, to the CCU 200, the low-frequency-component image subjected to the image processing, that has been supplied from the image processing unit 13, the encoded high-frequency-component images supplied from the first encoding unit 12, and the encoded difference information supplied from the second encoding unit 15.

Heretofore, the structure of the 4K Hi-Vision camera 100 has been described.

(Structure of CCU 200)

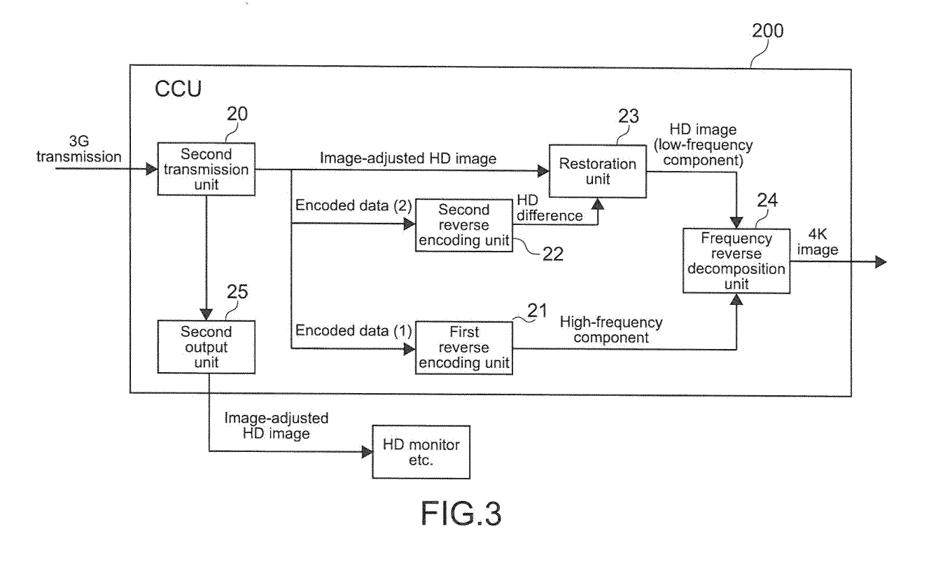

Next, a structure of the CCU 200 used in the embodiment of the present disclosure will be described. FIG. 3 is a block diagram showing the structure of the CCU 200 used in the embodiment of the present disclosure.

The CCU 200 (image pickup control apparatus) includes a second transmission unit 20 (input unit), a first reverse encoding unit 21, a second reverse encoding unit 22, a restoration unit 23, a frequency reverse decomposition unit 24, and a second output unit 25 (output unit).

The second transmission unit 20 receives the low-frequency-component image subjected to the image processing, the encoded high-frequency-component images, and the encoded difference information that have been transmitted from the 4K Hi-Vision camera 100. The second transmission unit 20 supplies the low-frequency-component image subjected to the image processing to the restoration unit 23 for restoring to the low-frequency-component image from before the image processing and also to the second output unit 25 for a monitor output. The second transmission unit 20 also supplies the encoded high-frequency-component images to the first reverse encoding unit 21 for decoding. The second transmission unit 20 also supplies the encoded difference information to the first reverse encoding unit 21 for decoding.

The second output unit 25 outputs, as an HD image, the low-frequency-component image subjected to the image processing, that has been supplied from the second transmission unit 20, to the external apparatus such as a monitor.

The first reverse encoding unit 21 carries out reverse encoding processing on the encoded high-frequency-component images that have been supplied from the second transmission unit 20 and decodes the images. The first reverse encoding unit 21 supplies the decoded high-frequency-component images to the frequency reverse decomposition unit 24 for an up-conversion to a 4K Hi-Vision image.

The second reverse encoding unit 22 carries out reverse encoding processing on the encoded difference information that has been supplied from the second transmission unit 20 and decodes the information. The second reverse encoding unit 22 supplies the decoded difference information to the restoration unit 23 for restoration to the low-frequency-component image from before the image processing.

The restoration unit 23 applies the decoded difference information supplied from the second reverse encoding unit 22 with respect to the low-frequency-component image subjected to the image processing, that has been supplied from the second transmission unit 20, and restores the image to the low-frequency-component image from before the image processing. The restoration unit 23 supplies the decoded low-frequency-component image from before the image processing to the frequency reverse decomposition unit 24 for an up-conversion to a 4K Hi-Vision image.

The frequency reverse decomposition unit 24 carries out a frequency reverse decomposition on the low-frequency-component image restored to a state from before the image processing, that has been supplied from the restoration unit 23, and the decoded high-frequency-component images supplied from the first reverse encoding unit 21, and restores the images to a 4K Hi-Vision image obtained at a photographed time point of the image pickup unit 10 of the 4K Hi-Vision camera 100. In other words, the frequency reverse decomposition unit 24 up-converts the low-frequency-component image, that is, the HD image restored to a state from before the image processing using the decoded high-frequency components and generates a 4K Hi-Vision image. The 4K Hi-Vision image output from the CCU 200 is used by an apparatus provided at a later stage than the CCU 200. It should be noted that the frequency reverse decomposition only needs to be carried out by a wavelet reverse conversion or the like.

Heretofore, the structure of the CCU 200 has been described.

(Supplementary Note)

It should be understood by those skilled in the art that various modifications, combinations, sub-combinations and alterations may occur depending on design requirements and other factors insofar as they are within the scope of the appended claims or the equivalents thereof.

(Other Structures of Present Disclosure)

The present disclosure may also take the following structures.

(1) An image pickup apparatus, including:

an image pickup unit configured to pick up an image;

a frequency decomposition unit configured to frequency-decompose the picked-up image into one or more high-frequency images of high frequency components and a low-frequency image of a low frequency component;

a first encoding unit configured to encode the high-frequency images to generate encoded high-frequency images;

an image processing unit configured to subject the low-frequency image to image processing to generate an adjusted low-frequency image;

a difference generation unit configured to generate difference information for the adjusted low-frequency image and the low-frequency image;

a second encoding unit configured to encode the difference information to generate encoded difference information; and

a transmission unit configured to transmit the encoded high-frequency images, the encoded difference information, and the adjusted low-frequency image.

(2) The image pickup apparatus according to (1) above,

in which the image processing unit carries out, as the image processing, at least detail processing for emphasizing an outline.

(3) The image pickup apparatus according to (1) or (2) above,

in which the frequency decomposition unit carries out the frequency decomposition by a wavelet conversion.

(4) The image pickup apparatus according to any one of (1) to (3), further including

an output unit configured to output the generated adjusted low-frequency image.

(5) An image pickup control apparatus, including:

an input unit configured to input encoded high-frequency images, encoded difference information, and an adjusted low-frequency image transmitted from an image pickup apparatus including
an image pickup unit that picks up an image,
a frequency decomposition unit that frequency-decomposes the picked-up image into one or more high-frequency images of high frequency components and a low-frequency image of a low frequency component,
a first encoding unit that encodes the high-frequency images to generate the encoded high-frequency images,
an image processing unit that subjects the low-frequency image to image processing to generate the adjusted low-frequency image,
a difference generation unit that generates difference information for the adjusted low-frequency image and the low-frequency image,
a second encoding unit that encodes the difference information to generate the encoded difference information, and
a transmission unit that transmits the encoded high-frequency images, the encoded difference information, and the adjusted low-frequency image;

a first reverse encoding unit configured to reverse-encode the encoded high-frequency images to restore them to the high-frequency images;

a second reverse encoding unit configured to reverse-encode the encoded difference information to restore it to the difference information;

a restoration unit configured to restore the low-frequency image from before the image processing based on the restored difference information and the adjusted low-frequency image; and

a frequency reverse decomposition unit configured to subject the restored high-frequency images and the restored low-frequency image to a frequency reverse decomposition to restore and output the image.

(6) The image pickup control apparatus according to (5) above,

in which the frequency reverse decomposition unit carries out the frequency reverse decomposition by a wavelet reverse conversion.

(7) The image pickup control apparatus according to (5) or (6) above, further including

an output unit configured to output the input adjusted low-frequency image.

What is claimed is:

1. An image pickup apparatus, comprising:
an image pickup unit configured to pick up an image;
a frequency decomposition unit configured to frequency-decompose the picked-up image into one or more high-frequency images of high frequency components and a low-frequency image of a low frequency component;
a first encoding unit configured to encode the high-frequency images to generate encoded high-frequency images;
an image processing unit configured to subject the low-frequency image to image processing to generate an adjusted low-frequency image;
a difference generation unit configured to generate difference information for the adjusted low-frequency image and the low-frequency image;
a second encoding unit configured to encode the difference information to generate encoded difference information; and
a transmission unit configured to transmit the encoded high-frequency images, the encoded difference information, and the adjusted low-frequency image.

2. The image pickup apparatus according to claim 1,
wherein the image processing unit carries out, as the image processing, at least detail processing for emphasizing an outline.

3. The image pickup apparatus according to claim 2,
wherein the frequency decomposition unit carries out the frequency decomposition by a wavelet conversion.

4. The image pickup apparatus according to claim 3, further comprising
an output unit configured to output the generated adjusted low-frequency image.

5. An image pickup control apparatus, comprising:
an input unit configured to input encoded high-frequency images, encoded difference information, and an adjusted low-frequency image transmitted from an image pickup apparatus including
an image pickup unit that picks up an image,
a frequency decomposition unit that frequency-decomposes the picked-up image into one or more high-frequency images of high frequency components and a low-frequency image of a low frequency component,
a first encoding unit that encodes the high-frequency images to generate the encoded high-frequency images,
an image processing unit that subjects the low-frequency image to image processing to generate the adjusted low-frequency image,
a difference generation unit that generates difference information for the adjusted low-frequency image and the low-frequency image,
a second encoding unit that encodes the difference information to generate the encoded difference information, and
a transmission unit that transmits the encoded high-frequency images, the encoded difference information, and the adjusted low-frequency image;
a first reverse encoding unit configured to reverse-encode the encoded high-frequency images to restore them to the high-frequency images;
a second reverse encoding unit configured to reverse-encode the encoded difference information to restore it to the difference information;
a restoration unit configured to restore the low-frequency image from before the image processing based on the restored difference information and the adjusted low-frequency image; and
a frequency reverse decomposition unit configured to subject the restored high-frequency images and the restored low-frequency image to a frequency reverse decomposition to restore and output the image.

6. The image pickup control apparatus according to claim 5,
wherein the frequency reverse decomposition unit carries out the frequency reverse decomposition by a wavelet reverse conversion.

7. The image pickup control apparatus according to claim 6, further comprising
an output unit configured to output the input adjusted low-frequency image.
